(19) United States
(12) Patent Application Publication
(10) Pub. No.: US 2006/0270444 A1
(43) Pub. Date: Nov. 30, 2006

(54) Full qwerty web-phone with optional second keypad

(76) Inventor: Ivan Miramontes, Fontana, CA (US)

Correspondence Address: SETO PATENTS, 406 RIVERLAND DR., SALEM, VA, 24153, US

(21) Appl. No.: 11/135,914

(22) Filed: May 25, 2005

(51) Int. Cl. H04M 1/00

(52) U.S. Cl. 455/550.1

(57) ABSTRACT

A web enabled personal communication device with a permanent keypad, a display screen and a second keypad. The permanent keypad provides a numeric keypad for dialing telephone numbers when the device is operated in the first mode, as a cellular telephone. The permanent keypad also presents the left half of a qwerty keyboard for data entry by the user when the device is operated in a second mode. In the preferred embodiment, the second keypad is hidden from view when the device is operated in the first mode, and exposed to the user when the device is operated in the second mode. The second keypad provides the right half of the qwerty keyboard to the user. When the device is operated in the second mode, the letters in the permanent keypad are enabled and provide the left half of a qwerty keyboard to the user. In alternative embodiments, the second keypad is detachable from the device.

### BACKGROUND OF THE INVENTION

The present invention relates generally to the field of web enabled cellular telephones and more specifically to a web enabled cellular telephone with an optional second keypad.

The present invention was originally disclosed in Disclosure Document No. 566353 received at the U.S. patent office on Dec. 6, 2004, and in Disclosure Document No. 571164 received at the U.S. patent office on Feb. 24, 2005.

Alexander Graham Bell invented the first telephone in 1876. The basic concept of transforming a human voice into an undulating current that is then used to reproduce the voice at a remote location is still in use today in some analog wire line systems. Advances in modern technology have added to the capabilities of the modern telephones wherein both voice and data can be carried over a telephone line in a digital form. Today, a physical telephone line today is not even a requirement as radio waves can now be used to carry voice and data. Such radio waves are used in cordless telephones found in many of today's households and also make cellular telephone systems possible.

A basic telephone set contains a transmitter that transfers the caller's voice, a receiver that amplifies sound from an incoming call, a rotary or push-button dial and, a ringer or alerter. A small assembly of electrical parts, called the anti-sidetone network that keeps the caller's voice from sounding too loud through the receiver is also included. A speakerphone has a microphone and speaker in the base in addition to the transmitter and receiver in the handset. Speakerphones allow callers' hands to be free, and allow more than two people to listen and speak during a call. In a cordless phone, the handset cord is replaced by a radio link between the handset and base, but a line cord is still used between the base and the telephone line. This allows a caller to move about in a limited area while on the telephone. A cellular phone has miniaturized components that make it possible to combine the base and handset into one handheld unit. No line or handset cord is needed with a cellular phone thereby providing maximum mobility.

A cellular telephone is designed to give the user maximum freedom of movement while using a telephone. A cellular telephone uses radio signals to communicate between the “cell phone” and a base station, via an antenna. The served area is divided into cells something like a honeycomb, and an antenna is placed within each cell and connected by telephone lines to one exchange devoted to cellular-telephone calls. This exchange connects cellular telephones to one another and transfers the call to a regular exchange, public switched telephone network, if the call is between a cellular telephone and a non-cellular telephone. The special cellular exchange, through computer control, selects the antenna closest to the telephone when service is requested. As the telephone roams, the exchange automatically determines when to change the serving cell based on the power of the radio signal received simultaneously at adjacent sites. This change occurs without interrupting conversation. Practical power considerations limit the distance between the telephone and the nearest cellular antenna, and since cellular phones use radio signals, it is possible for unauthorized people to access communications carried out over cellular phones. One of the reasons why digital cell phones have gained in popularity, besides being able to access the Internet, is because their radio signals are harder to intercept and decode.

Analog transmission, in which speech or data is converted directly into a varying electrical current, is suitable for local calls. But once the call involves any significant distance, the necessary amplification of the analog signal can add so much noise that the received signal becomes unintelligible. For long-distance calls, the signal is digitized, or converted to a series of pulses that encodes the information. When an analog electrical signal is digitized, samples of the signal's strength are taken at regular intervals, usually about 8000 samples per second. Each sample is converted into a binary form; a number made up of a series of 1s and 0s. This number is easily and swiftly passed through the switching system. Digital transmission systems are much less subject to interfering noise than are analog systems. The digitized signal can then be passed through a digital-to-analog converter (DAC) at a point close to the receiving party, and converted to a form that the ear cannot distinguish from the original signal. There are several ways a digital or analog signal may be transmitted, including coaxial and fiber-optic cables and microwave and longwave radio signals sent along the ground or bounced off satellites in orbit around the earth. A coaxial wire, like the wire between a videocassette recorder (VCR) and a television set, is an efficient transmission system. A coaxial wire has a conducting tube surrounding another conductor. A coaxial cable contains several coaxial wires in a common outer covering. The important benefit of a coaxial cable over a cable composed of simple wires is that the coaxial cable is more efficient at carrying very high frequency currents. This is important because in providing transmission over long distances, many telephone conversations are combined using frequency modulation (FM) techniques similar to the combining of many channels in the television system. The combined signal containing hundreds of individual telephone conversations is sent over one pair of wires in a coaxial cable, so the signal has to be very clear.

Fiber optic cable offer another telephone-transmission method that uses bundles of optical fibers, long strands of specially made glass encased in a protective coating. Optical fibers transmit energy in the form of light pulses. The technology is similar to that of the coaxial cable, except that the optical fibers can handle tens of thousands of conversations simultaneously. Another approach to long-distance transmission is the use of radio. Before coaxial cables were invented, very powerful longwave (low frequency) radio stations were used for intercontinental calls. Microwave radio uses very high frequency radio waves and has the ability to handle a large number of simultaneous conversations over the same microwave link. Because cable does not have to be installed between microwave towers, this system is usually cheaper than coaxial cable. On land, the coaxial-cable systems are often supplemented with microwave-radio systems. The technology of microwave radio is carried one step further by the use of communications satellites. Most communications satellites are in geosynchronous orbit—that is, they orbit the earth once a day over the equator, so the satellite is always above the same place on the earth's surface. That way, only a single satellite is needed for continuous service between two points on the surface, provided both points can be seen from the satellite. A combination of microwave, coaxial cable, optical fiber, and satellite paths now link the major cities of the world. The capacity of each type of system depends on its age and the territory covered, but capacities generally fall into the following ranges: frequency modulation over a simple pair of wires like the earliest telephone lines yields tens of circuits (a circuit can transmit one telephone conversation) per pair; coaxial cable yields hundreds of circuits per pair of conductors, and thousands per cable; microwave and satellite transmissions yield thousands of circuits per link; and optical fiber has the potential for tens of thousands of circuits per fiber.

Computer-controlled exchange switches make it possible to offer a variety of extra services to both the residential and the business customer. Some services to which users may subscribe at extra cost are call waiting, in which a second incoming call, instead of receiving a busy signal, hears normal ringing while the subscriber hears a beep superimposed on the conversation in progress; and three-way calling, in which a second outgoing call may be placed while one is already in progress so that three subscribers can then talk to each other. Other services available to users are: caller ID, in which the calling party's number is displayed to the receiver on special equipment before the call is answered; and repeat dialing, in which a called number, if busy, will be automatically redialed for a certain amount of time. Of course users have the ability to block their name and phone from being displayed on a caller ID display. Another popular service is voice mail. While traditional answering machines cannot take a message if a caller is already on the line, voice mail creates a second virtual line. While a caller is talking to one party, a second incoming call is greeted with a message asking the second party to leave a message. The user will then be notified of the waiting message.

Unified messaging and the arrival of mobile Internet services means Short Message Service (SMS), a mobile messaging service, will soon become the primary alert mechanism for users to check and pick up their e-mail, fax or voice messages. The rapidly growing availability of WAP (Wireless Application Protocol) has enabled handsets to enhance the customer experience of reading and sending more messages. The arrival of the GSM (Global System for Mobile communications) family's next phase of evolution in the form of GPRS (General Packet Radio Services) will ensure faster speeds and boost the variety of mobile services available significantly. Mobile banking, M-Commerce, and customer service applications are also bolstering SMS traffic. The arrival of more advanced data services will yet again increase demand. During the First (1G) and Second (2G) Generations of mobile communications different regions of the world pursued different mobile phone standards. Europe pursued NMT and TACS for analog and GSM for digital. North America pursued AMPS for analog and a mix of TDMA, CDMA and GSM for digital. The Third Generation (3G), based on CDMA technology, will bring these incompatible standards together and allow convergence toward a common standard for mobile multimedia.

### SUMMARY OF THE INVENTION

A personal communication device that provides a user with voice and data communications. The device being operable in a closed position wherein the device primarily provides voice communications and an open position wherein the device also provides enhanced text messaging, Internet browsing and gaming capabilities. The personal communication device comprises a housing, a display screen, a first keypad and a second keypad. The housing has a front, a back and an interior, the interior contains cellular telephone circuitry and other circuitry including gaming circuitry. The display screen is attached to the front of the housing and displays text and image information to the user. The first keypad is attached to the front of the housing below the display screen and is permanently exposed to the user. The first keypad includes separate keys for each single-digit number, zero through nine. The first keypad also includes separate keys for each letter in the left half of a qwerty keyboard. The second keypad is permanently and moveably attached to the back of the housing. The second keypad is exposed to the user when the device is in the open position and hidden behind the housing when the device is in the closed position. The second keypad includes separate keys for each letter in the right half of the qwerty keyboard so that when the device is in the open position the user has access to a full qwerty keyboard.

The device preferably includes a digital camera that is able to capture still and moving pictures. The display screen is capable of displaying the pictures captured by the camera. The digital camera is able to rotate 180 degrees, so that the camera can face toward the user and can also face away from the user.

The first keypad preferably includes a four or five way navigational key. The second keypad preferably includes an “Enter” key and a space bar. The device further preferably includes wireless data transmission applications that are compatible with SIM Application Toolkit, Wireless Application Protocol (WAP), Bluetooth technology, Wi-Fi/Wi-Max and a TV tuner. The device also preferably is capable of using Short Message Service (SMS), Multi-media Messaging Service (MMS), Instant Messaging (IM), e-mail, and includes predictive text software.

In an alternative embodiment the second keypad is rotate-ably attached to the housing and the second keypad can be flipped between two opposite sides to alternatively expose half of a qwerty keyboard and a gaming control pad to the user. This alternative embodiment includes a pivoting base that facilitates movement of the second keypad between the open position and the closed position. The second keypad is hidden behind the housing in the closed position and swung 90 degrees to a position to a right of the first keypad in the open position. An optional cover can be provided to protect the exposed side of the second keypad when the device is in the closed position. Other alternative embodiments include detachable second keypads, which can optionally include a secondary battery pack.

It is an object of the present invention to provide a personal communication device that supports cellular communications and Internet access.

It is another object of the present invention to provide a full qwerty keyboard to the user for typing text messages and accessing the Internet.

It is yet another object of the invention to provide a web enabled cellular telephone to the user that also includes gaming controls that allows the user to play video games on the device.

### BRIEF DESCRIPTION OF THE DRAWINGS

The invention of the present application will now be described in more detail with reference to the accompanying drawings, given only by way of example, in which:

FIG. 1 is a frontal view of the preferred embodiment in the closed position;

FIG. 2 is a frontal view of the preferred embodiment in the open position;

FIG. 3 is a bottom view of the preferred embodiment in the closed position;

FIG. 4 is a bottom view of the preferred embodiment in the open position;

FIG. 5 is a frontal view of an alternative embodiment in the open position;

FIG. 6 is another frontal view of the alternative embodiment in the open position;

FIG. 7 is a back view of the alternative embodiment in the closed position;

FIG. 8 is a frontal view of a second alternative embodiment;

FIG. 9 is a frontal view of a third alternative embodiment;

FIG. 10 is a frontal view of a fourth alternative embodiment in the closed position;

FIG. 11 is a frontal view of the fourth alternative embodiment in the open position;

FIG. 12 is a frontal view of a fifth alternative embodiment in the open position;

FIG. 13 is a back view of the fifth alternative embodiment in the open position; and,

FIG. 14 is a back view of the fifth alternative embodiment in the closed position.

### DETAILED DESCRIPTION OF THE INVENTION

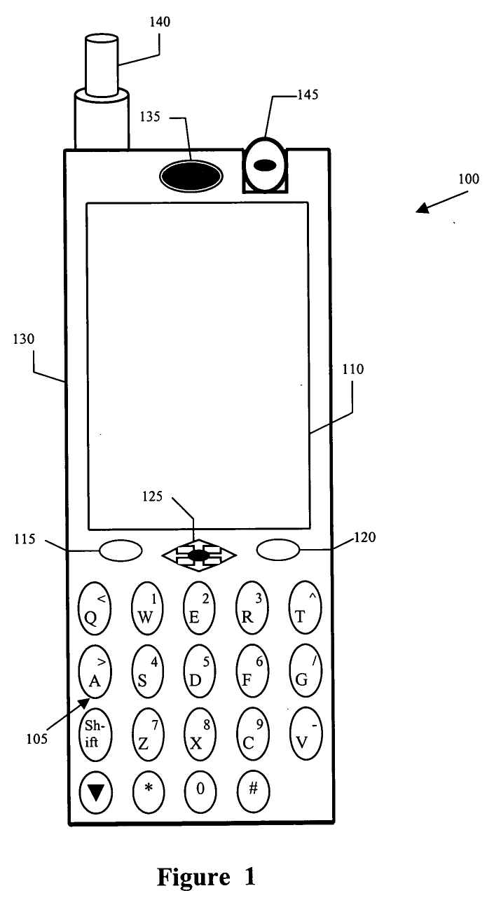

FIG. 1 shows the preferred embodiment 100 of the present communication device in the closed position. The present device provides the user with voice, text and Internet communications. The preferred embodiment 100 can be used as a mobile telephone, a hand held personal digital assistant (PDA) or as a cordless handset for a cordless telephone set. The preferred embodiment 100 includes a primary keypad 105. The primary keypad 105 is always exposed for access by the user. The primary keypad 105 includes numbers, zero through nine, and letters, generally representing the left half of a full qwerty keyboard. The term “qwerty” refers to the full sized keyboards found on typewriters and desktop computers. Qwerty keyboards provide one key for each letter and can be contrasted with traditional telephone keypads that assign three or four letters to each key. The preferred embodiment also includes a display screen 110. Between the display screen 110 and the primary keypad 105 are the “end call” button 115, the “send” button 120 and a five way navigational key 125. Supported at the top of the communication device's housing 130 are antenna 140, speaker 135 and digital camera 145. When the preferred embodiment 100 is in the closed position, shown in FIG. 1, the device operates in a first mode. In the first mode the numbers on the primary keypad 105 are enabled and the device primarily provided voice communications to the user.

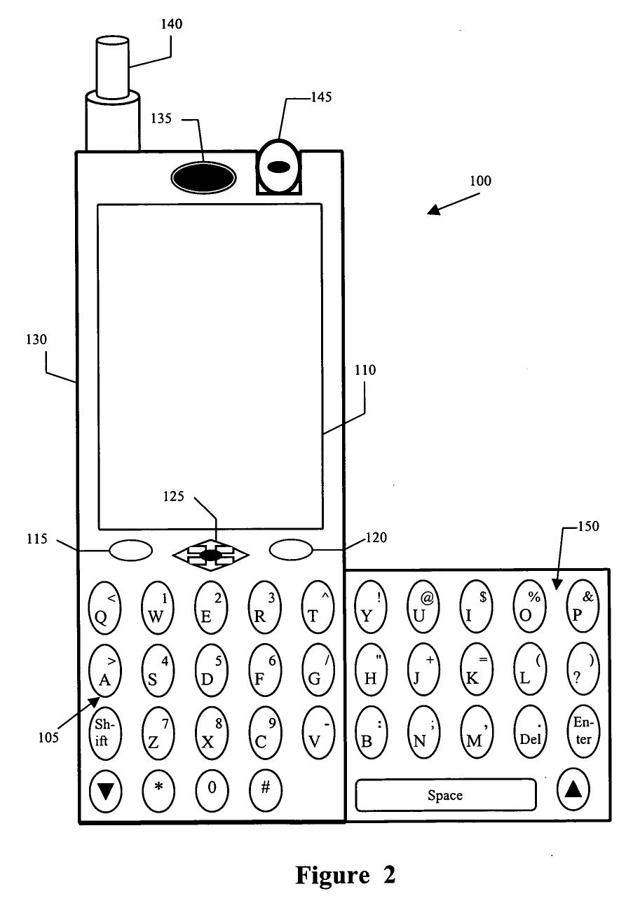

FIG. 2 shows the preferred embodiment 100 in the open position. In the open position the second keypad 150 is slid out from behind the primary keypad 105 to expose the right half of the qwerty keyboard. When the preferred embodiment 100 is in the open position the communication device operates in a second mode. In the second mode the letters in the primary keypad 105 are enabled and the keys on the second keypad 150 are also enabled. When the user moves the device to the open position, text messaging and/or browser programs stored in the hardware of the device are automatically activated and executed. The programs provide the user with enhanced text messaging capabilities and Internet browsing capabilities. The cellular telephone capabilities and the digital camera 115 are each operable in the both the open and closed positions.

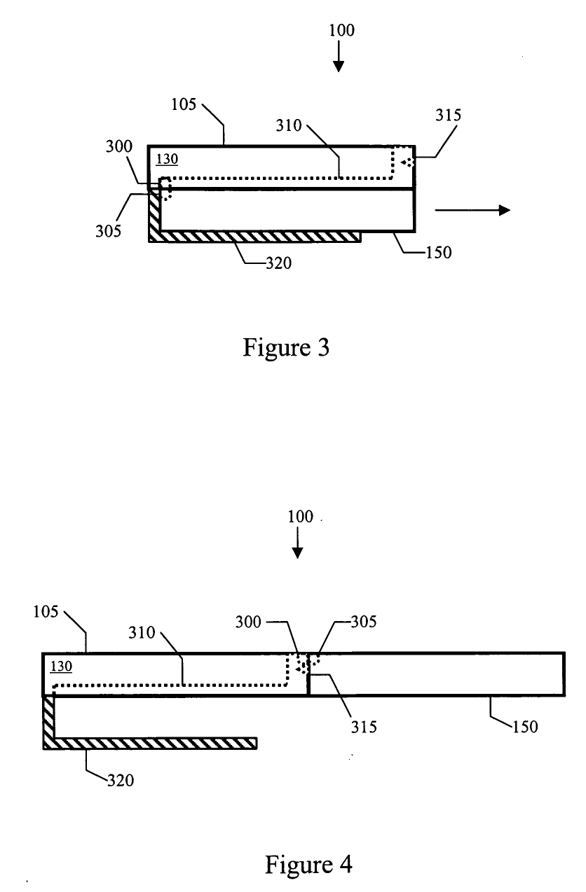

FIG. 3 shows the bottom of the preferred embodiment 100 while in the closed position. Inside the housing 130 of the preferred embodiment 100 is at least one track 310 along which trackball 300 is allowed to traverse. Trackball 300 is connected to trackball 305. The second keypad 150 is hidden behind the primary keypad 105 and held flush against the housing 130 by bracket 320, while in the closed position.

FIG. 4 shows the bottom of the preferred embodiment 100 while in the open position. To move the device to the open position, the user can grasp the edges of the second keypad 150 and slide the keypad out, so the second keypad 150 is exposed, and the slide it up, so the second keypad 150 is at the same height as the primary keypad 105. As the user moves the second keypad 150, the trackball 300 simultaneously moves along the track 310. As the user moves the second keypad 150 up to the same height as the primary keypad 105, the trackball 300 is forced over friction stop 315, which holds the second keypad 150 in place. In other embodiments, the second keypad only slides out, so that it is exposed. The second keypad does not also slide up to the height of the primary keypad. Of course, other mechanisms besides the trackball mechanism shown in FIGS. 3 and 4 can also be used to facilitate movement of the second keypad between the open and closed positions.

The preferred embodiment 100 includes hardware and software for supporting Short Messaging Service (SMS), Multi-media Messaging Service (MMS), Instant Messaging (IM), Electronic Mail (e-mail), Bluetooth technology, Wi-Fi/Vi-Max, memory cards or sticks, and the viewing of television.

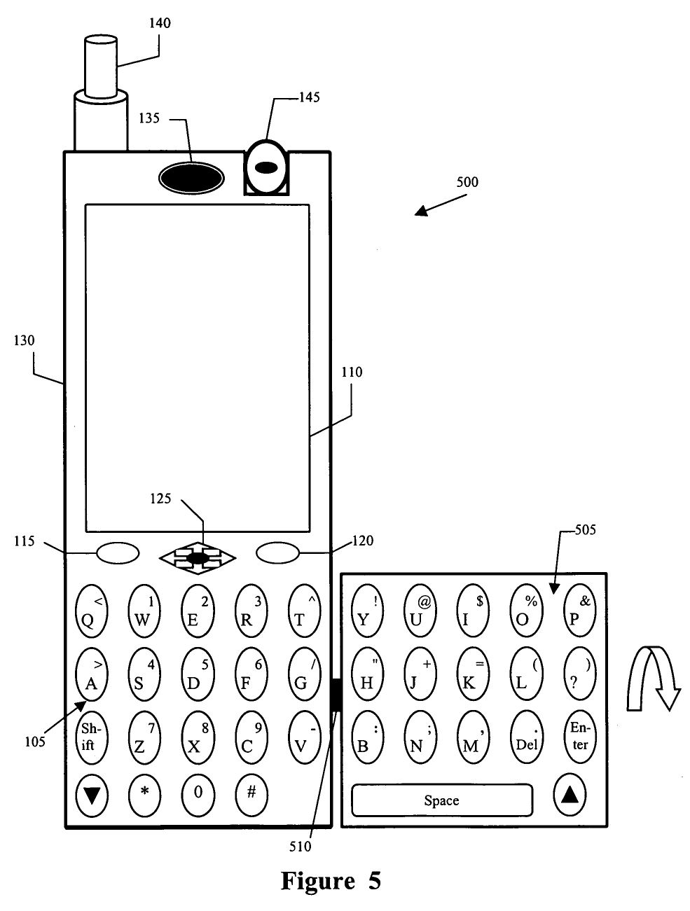

FIG. 5 is a frontal view of an alternative embodiment 500 of the present personal communication device, in the open position. The difference between the alternative and preferred embodiments is the second keypad. In the alternative embodiment 500, the second keypad had two sides, each of which can be rotated to face the user. In FIG. 5, the qwerty side 505 of the second keypad is facing the user. The second keypad is attached to the housing 130 by shaft 510. Shaft 510 also facilitates rotation of the second keypad.

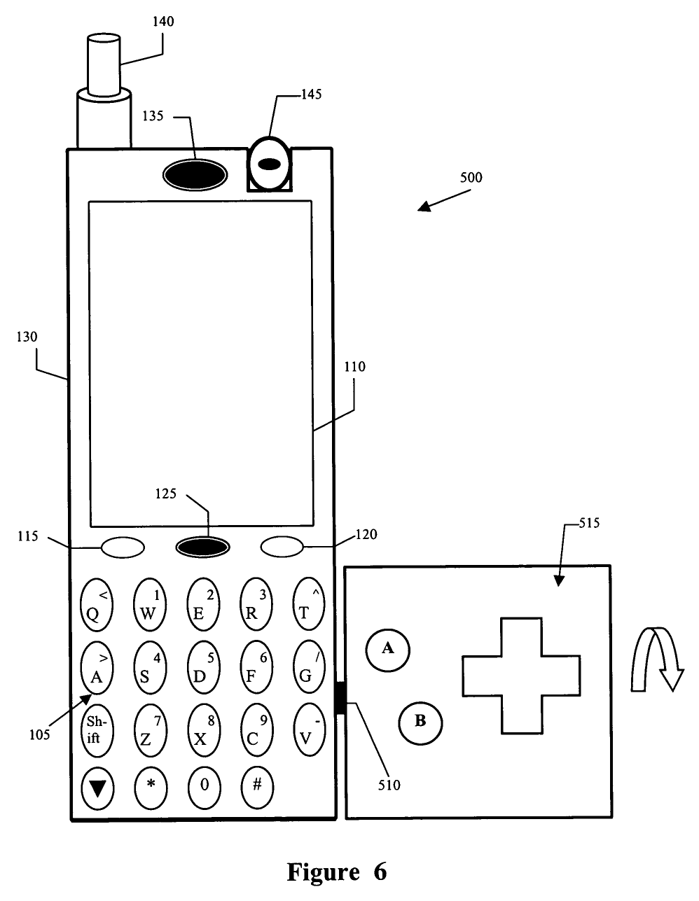

FIG. 6 is another frontal view of the alternative embodiment 500 in the open position. In this figure, the second keypad has been rotated 180 degrees so that the gaming side 515 of the second keypad faces the user. The second keypad is rotated about shaft 510. The alternative embodiment 500 includes hardware and software for providing the user with enhanced text messaging, Internet browsing and gaming capabilities.

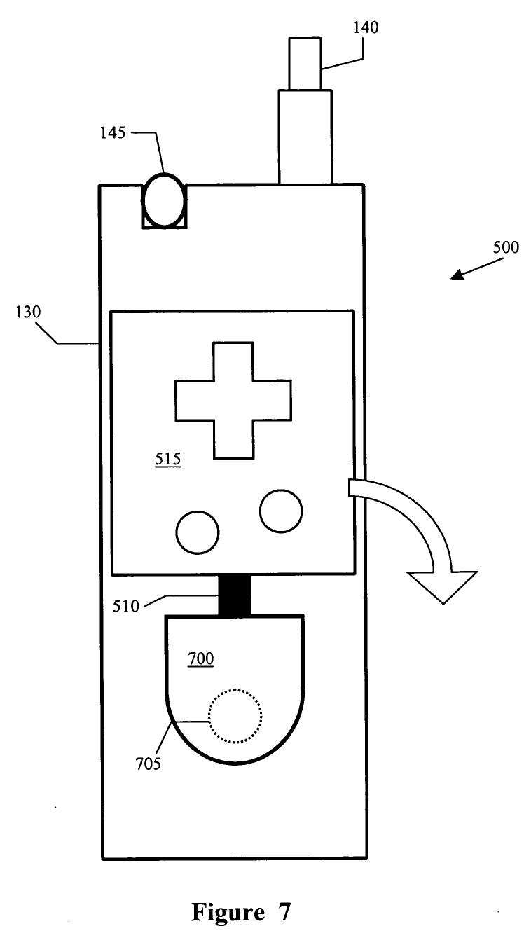

FIG. 7 is a back view of the alternative embodiment 500 in the closed position. The second keypad is attached to the backside of the housing 130 by rotate-able base 700. The rotate-able base 700 is allowed to rotate 90 degrees so that the second keypad can be exposed for use. Internal circular structure 705 assists the base 700 in moving the device between the open and closed positions. Shaft 510 connects the second keypad to the rotate-able base 700. A removable cover can optionally be provided with the alternate embodiment 500 to cover the exposed side 515 of the second keypad, while in the closed position. The cellular telephone and digital camera capabilities are available to the user both when the alternate embodiment 500 is in the open and closed positions.

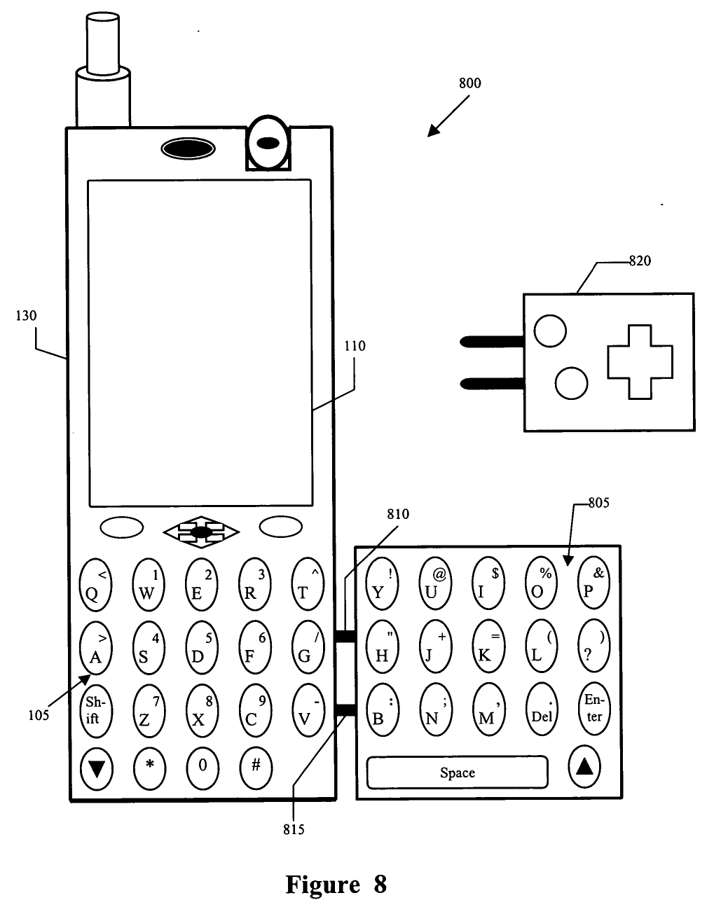

FIG. 8 is a frontal view of a second alternative embodiment 800. In this embodiment 800, the second keypad 805 is plugged into the side of the communication device. The second keypad 805 includes two prongs 810 & 815 that the keypad 805 uses to temporarily attach to, and communicate with, the device. The second keypad 805 may also include a battery pack that can be used to power the second alternative embodiment 800. Thus, if the battery within the housing 130 of the device is dead, the user can still operate the device by plugging the second keypad 805 into the side of the device. Multiple second keypads can be provided with this embodiment 800 each providing fresh battery power when plugged in. The second keypad may also be provided as a gaming keypad 820 that provides gaming controls for use with gaming software executed within the device. Gaming keypad 820 is shown smaller than the second keypad 805 for ease of illustration only. In reality the gaming keypad 820 and its two prongs are identical in size to the second keypad 805 and its two prongs 810 and 815. Gaming keypad 820 may also include a battery pack for providing power to this embodiment 800.

When the second keypad 805 is plugged into the side of the housing 130, the device automatically switches from a first mode to a second mode. In the first mode the device is used primarily as a cellular telephone. The second mode facilitates use of the device as a text messaging assistant and Internet browser. In the second mode, the letters are enabled on the primary keypad 105, and the keys on the second keypad 805 are enabled. Also in the second mode, text messaging and/or browser programs within the communication device are executed that provide the user with enhanced text messaging capabilities and Internet browsing capabilities, respectively. Preferably a bracket or pocket is provided on the back of the housing 130 to hold the second keypad 805 when it is not being used, and/or to hold other second keypads. The cellular telephone and digital camera capabilities are available to the user in both modes.

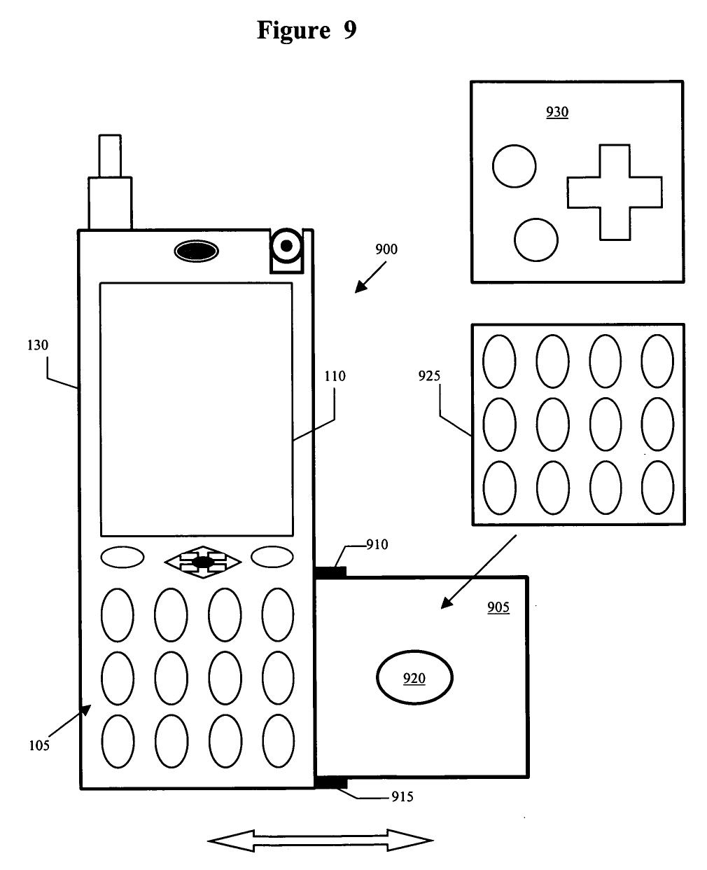

FIG. 9 is a frontal view of a third alternative embodiment 900 in the open position. In this embodiment 900 an extendable keypad cradle 905 is provided in the housing 130 of the communication device. The keypad cradle 905 works in the same manner as a compact disk (CD) cradle in a laptop or desktop computer. The cradles are hidden from view when in the closed position, and with a simple push on the side of the cradle, the cradle is released from its housing and can be fully extended to achieve the open position. The present keypad cradle 905 is attached to the housing via slide-able arms 910 & 915, which preferably follow tracks within the housing. The keypad cradle 905 is designed to accept and temporarily hold multiple different secondary keypad plates, such as secondary keypad plates 925 & 930. Secondary keypad plate 925 provides keys that when matched with the primary keypad 105 gives the user a full qwerty keyboard. Secondary keypad plate 930 provides gaming controls for playing video games on the device. When the keypad cradle 905 is moved from the closed position, behind the primary keypad 105, to the open position, shown in FIG. 9, the device automatically switches from a first operating mode, wherein the device is primarily used as a telephone, to a second operating mode, wherein the device can also be used as a PDA, an Internet browser and a gaming device. The keypad plates 925 & 930 can be pressed down into the keypad cradle 905 for temporary docking, and the keypad plates 925 & 930 can be removed from the keypad cradle 905 by pressing on the back of the keypad plate through a hole 920 in the center of the keypad cradle 905.

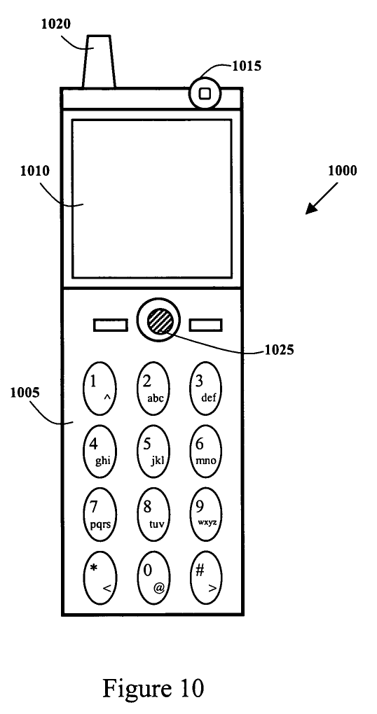

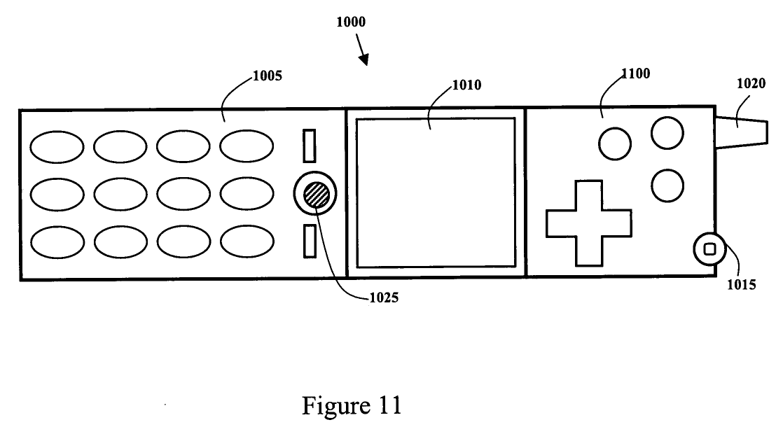

FIG. 10 is a frontal view of a fourth alternative embodiment 1000 in the closed position. This embodiment 1000 is a stand-alone gaming phone. While the device is in the closed position it is primarily used as a telephone. When the device is moved to the open position, shown in FIG. 11, it is used as a gaming device. The keypad 1005 of this embodiment 1000 is similar to a traditional telephone keypad, with multiple letters assigned to one pad. This embodiment 1000 includes an antenna 1020 and a digital camera 1015. Display screen 1010 provides information to the user, while the device is in the closed position, and displays graphics to the user when the device is in the open position. Joystick 1025 provides gaming controls for the user when the embodiment 1000 is used as a gaming device. The joystick 1025 may also function as a four or five way navigational key.

FIG. 11 is a frontal view of the fourth alternative embodiment 1000 in the open position. While in the open position this embodiment 1000 is used as a gaming device. The gaming software can be stored locally or downloaded wirelessly for execution on the device. The game pad 1100 is hidden behind the display screen 1010 when the device is in the closed position. The edges of the game pad 1100 are grasped by the user and the game pad 1100 is slid straight out from behind the display screen 1010 to move the device to the open position. In the open position, the front of the display screen 1010 is elevated and slightly closer to the user than the front of the game pad 1100. When the game pad 1100 is exposed, the device switches from a telephone mode to a gaming mode, wherein a menu of games are immediately displayed for the user to select from. Other types of gaming controls, other than those shown in FIG. 11 can be provided on the game pad.

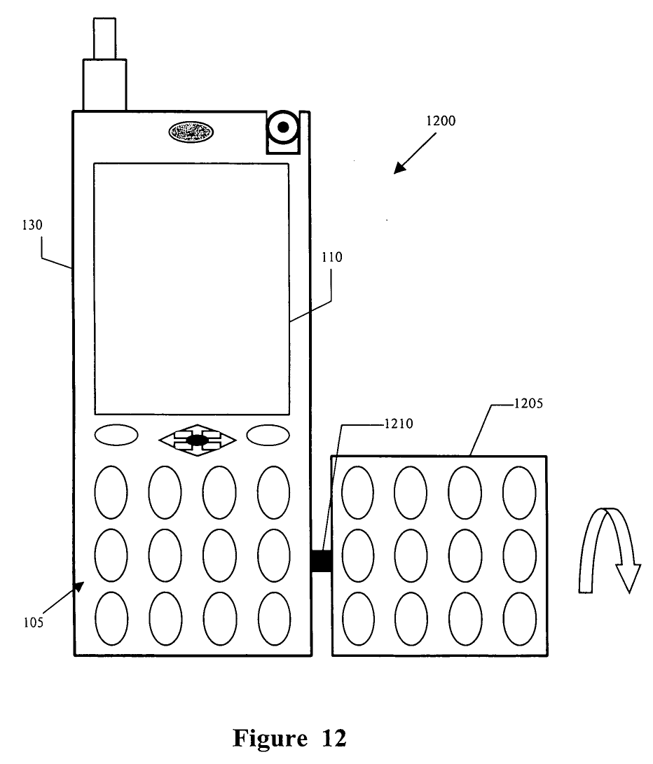

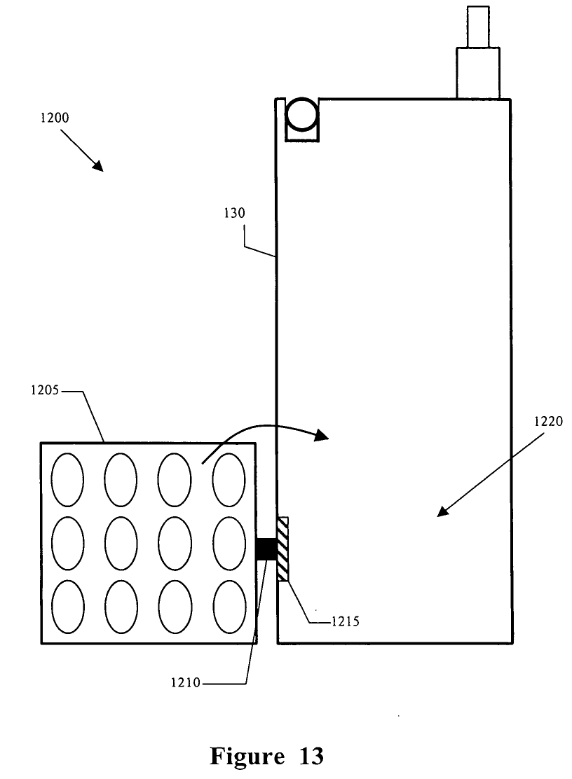

FIG. 12 shows the front of a fifth alternative embodiment 1200 in the fully open position. In this position the primary keypad 105 and the second keypad 1205 provide the user with a full qwerty keyboard. In this embodiment, the second keypad 1205 is able to rotate 180 degrees around shaft 1210 and subsequently fold closed to the back of the housing 130,.illustrated in FIGS. 13 & 14.

FIG. 13 is a back view of embodiment 1200 during preparation of the device for movement to the closed position. The second keypad 1205 has been rotated 180 degrees so that it faces away from the user. In the closed position, the second keypad 1205 is folded closed, via hinge 1215, against the back 1220 of the housing 130. Rotating the second keypad 1205 prior to folding allows the keys to be protected while in the closed position.

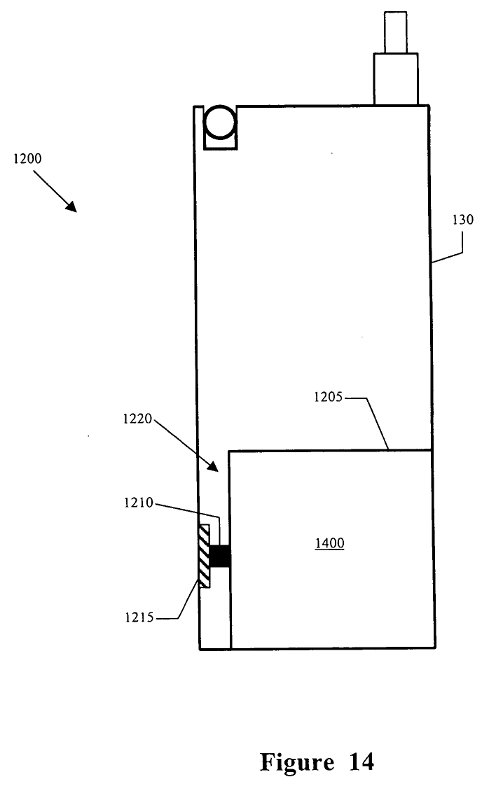

FIG. 14 is a back view of embodiment 1200 in the closed position. In the closed position, the second keypad 1205 is folded closed against the back 1220 of the housing 130 so that only the hard back 1400 of the second keypad is exposed. Of course, hinge 1215 and shaft 1210 can be covered in other embodiments.

The foregoing description of the specific embodiments will so fully reveal the general nature of the invention that others can, by applying current knowledge, readily modify and/or adapt for various applications such specific embodiments without departing from the generic concept. Therefore, such adaptations and modifications should and are intended to be comprehended within the meaning and range of equivalents of the disclosed embodiments. It is to be understood that the phraseology of terminology employed herein is for the purpose of description and not of limitation.

I claim:

1. A personal communication device that provides a user with voice and data communications, the communication device having a closed position wherein the device primarily provides voice communications and an open position wherein the device also provides enhanced text messaging, Internet browsing and gaming capabilities, the personal communication device comprising:
a housing, the housing having a front, a back and an interior, the interior of the housing containing cellular telephone circuitry and other circuitry including gaming circuitry;
a display screen for displaying text and image information to the user, the display screen being attached to the front of the housing;
a first keypad, the first keypad being attached to the front of the housing below the display screen and permanently exposed to the user, wherein the first keypad includes separate keys for each single-digit number, zero through nine, and also includes separate keys for each letter in a left half of a qwerty keyboard; and,
a second keypad, the second keypad being permanently and moveably attached to the back of the housing, wherein the second keypad is exposed to the user when the device is in the open position and the second keypad is hidden behind the housing when the device is in the closed position, the second keypad including separate keys for each letter in a right half of the qwerty keyboard so that when the device is in the open position the user has access to a full qwerty keyboard.

2. The device of claim 1, further comprising a digital camera, the digital camera being able to capture still and moving pictures, wherein the display screen is capable of displaying the pictures captured by the camera, and further wherein the digital camera is able to rotate 180 degrees, so that the camera can face toward the user and can also face away from the user.

3. The device of claim 2, wherein the first keypad includes a navigational key and the second keypad includes an “Enter” key and a space bar, and wherein the device further comprises wireless data transmission applications that are compatible with SIM Application Toolkit, Wireless Application Protocol (WAP), Bluetooth technology, Wi-Fi/Wi-Max and a TV tuner.

4. The device of 3, wherein the device is capable of using Short Message Service (SMS), Multi-media Messaging Service (MMS), Instant Messaging (IM), e-mail, and includes predictive text software.

5. The device of claim 4, wherein the back of the housing includes a track mechanism and the track mechanism is used to slide-ably attach the second keypad to the housing, the track mechanism allowing the second keypad to be slid from the closed position, behind the first keypad, to the open position, to a right of the first keypad.

6. The device of claim 5, wherein the second keypad is also raised to a height of the first keypad when in the open position.

7. The device of claim 4, wherein a pivoting base is attached to the back of the housing and the second keypad is attached to the housing via the pivoting base, the pivoting base facilitating movement of the second keypad between the open position and the closed position, wherein the second keypad is hidden behind the housing in the closed position and swung 90 degrees to a position to a right of the first keypad in the open position.

8. The device of claim 7, wherein the second keypad has two sides with the right half of the qwerty keyboard on a front side and a set of gaming controls on a back side of the second keypad, and further wherein the second keypad is attached to the pivoting base by a rotating shaft, the rotating shaft allowing the user to flip the second keypad so that either the front side or the back side is facing the user when the device is in the open position, and the device further comprising a cover that protects an exposed side of the second keypad when the device is in the closed position.

9. The device of claim 1, the device further comprising a hinge that is used to permanently and moveably attach the second keypad to the back of the housing, the hinge allowing the second keypad to fold closed against the back of the housing, and the device further comprising a shaft that is used to connect the second keypad to the hinge, the shaft allowing the second keypad to rotate 180 degrees about the shaft.

10. A personal communication device that provides a user with voice and data communications, the communication device capable of operating in a first mode wherein the device primarily provides voice communications and a second mode wherein the device also provides enhanced text messaging, Internet browsing and gaming capabilities, the personal communication device comprising:
a housing, the housing having a front, a right side and an interior, the interior containing cellular telephone circuitry for sending and receiving information wirelessly and other circuitry including gaming circuitry for storing and executing gaming programs;
a display screen for displaying text and image information to the user, the display screen being attached to the front of the housing;
a first keypad, the first keypad being attached to the front of the housing below the display screen and permanently exposed to the user, wherein the first keypad includes separate keys for each single-digit number, zero through nine, and also includes separate keys for each letter in a left half of a qwerty keyboard; and, a second keypad, the second keypad being releasably attached to the right side of the housing, wherein the device operates in the first mode when the second keypad is not attached and operates in the second mode when the second keypad is attached, the second keypad including separate keys for each letter in a right half of the qwerty keyboard so that when the second keypad is attached to the device the user has access to a full qwerty keyboard.

11. The device of claim 10, further comprising a digital camera, the digital camera being able to capture still and moving pictures, wherein the display screen is capable of displaying the pictures captured by the camera, and further wherein the digital camera is able to rotate 180 degrees, so that the camera can face toward the user and can also face away from the user.

12. The device of claim 11, wherein the first keypad includes a navigational key and the second keypad includes an “Enter” key and a space bar, and wherein the device further comprises wireless data transmission applications that are compatible with SIM Application Toolkit, Wireless Application Protocol (WAP), Bluetooth technology, Wi-Fi/Wi-Max and a TV tuner.

13. The device of claim 12, wherein the device is capable of using Short Message Service (SMS), Multi-media Messaging Service (MMS), Instant Messaging (IM), e-mail, and includes predictive text software, and further wherein the second keypad includes a battery pack that can be used to power the device when the second keypad is attached to the housing.

14. The device of claim 13, wherein the right side of the housing includes two female adapters and a left side of the second keypad includes two male adapters, the female adapters capable of accepting and temporarily holding the male adapters and thereby temporarily attaching the second keypad to the right side of the housing, the male and female adapters also providing electrical pathways, including at least one communications connection, between the second keypad and the device.

15. The device of 14, further comprising a third keypad, the third keypad including two male adapters, similar to the adapters on the second keypad, the third keypad able to be plugged into the female adapters on the right side of the housing, wherein the third keypad also includes gaming controls that allow the user to select and play video games on the device.

16. The device of claim 5, wherein the second keypad is a keypad cradle that is capable accepting keypad plates, and wherein the device further comprises a first keypad plate, the first keypad plate having a separate key for each letter in the right half of the qwerty keyboard and capable of being temporarily connected to the keypad cradle.

17. The device of claim 16, further comprising a second keypad plate, the second keypad plate having a set of gaming controls and capable of being temporarily connected to the keypad cradle.

18. A personal communication device that provides a user with voice and data communications, the communication device having a closed position wherein the device primarily provides voice communications and an open position wherein the device also facilitates Internet access and provides gaming capabilities, the personal communication device comprising:
a housing, the housing having a front, a back and an interior, the interior containing cellular telephone circuitry and other circuitry including gaming circuitry;
a display screen for displaying text and image information to the user, the display screen being attached to the front of the housing;
a first keypad, the first keypad being attached to the front of the housing below the display screen and permanently exposed to the user, wherein the first keypad includes a tradition telephone keypad with separate keys for each single-digit number, zero through nine; and,
a game pad, the game pad being slide-ably attached to the back of the housing and being hidden from view behind the display screen when the device is in the closed position and slid out from behind the display screen so that it is exposed to the user when the device is in the open position, the game pad having gaming controls that allow the user to control video games played on the device.

19. The device of claim 18, further comprising a digital camera that can rotate at least 180 degrees and wherein the first keypad further comprises a joystick that the user can use to control gaming programs and as a navigational key.

20. The device of claim 19, wherein the digital camera and the voice communications are operable in both the first mode and the second mode.
